(19) United States
(12) Patent Application Publication
(10) Pub. No.: US 2012/0119660 A1
(43) Pub. Date: May 17, 2012

(54) LIGHTING COMPENSATION FOR APPLIANCES

(75) Inventors: Daniel Vincent Brosnan, Louisville, KY (US); Andrew L. Reder, Louisville, KY (US); Brian Michael Schork, Louisville, KY (US); Bryan James Beckley, Louisville, KY (US)

(73) Assignee: GENERAL ELECTRIC COMPANY, Schenectady, NY (US)

(21) Appl. No.: 12/947,897

(22) Filed: Nov. 17, 2010

(51) Int. Cl. H05B 37/02

(52) U.S. Cl. 315/153

(57) ABSTRACT

Apparatus and methodology is provided to control lighting associated with an appliance. Ambient light proximate the appliance and/or light from one or more lighting devices associated with the appliance is monitored and used to control the energization of the appliance lighting devices. Lighting device may include illumination devices as well as indicia display devices. The controller is configured to compensate lighting levels over the lifetime of the lighting devices to provide consistent lighting from the appliance lighting under all operating conditions.

### FIELD OF THE INVENTION

The present subject matter relates to lighting for appliances. More particularly, the present subject matter relates to control for all operating conditions of lighting associated with appliances.

### BACKGROUND OF THE INVENTION

In the life cycle of an appliance it is natural for the lighting systems to dim over time. This is generally true for LED's, LED Backlighting, vacuum fluorescent displays (VFDs), and other types of appliance lighting. Typically the driving method provided for appliance lighting is determined and set for the life of the appliance and is never changed.

United States Patent Application Publication US 20080094518 to Bennett entitled “System and Method for Controlling TV Display Lamp Brightness” describes a remote control signal receiver for a TV that sends not only user-generated commands to the TV processor but also, when no commands are sensed, an ambient light signal that can be used to adjust the brightness of the TV

United States Patent Application Publication US 20060149607 to Sayer et al. entitled “LED Lighting System” describes a method for optimizing an LED lighting system cost including determining LED costs, power source costs, and total costs associated with a plurality of LED quantities, and identifying a lowest total cost as an optimal cost. The disclosed LED lighting system includes an LED operated by a constant-current driver at less than its maximum current capacity. A programmable controller including a feedback routine is used to compensate for intensity drift as an LED ages.

In view of these known concerns it would be advantageous to provide lighting systems that provide compensations that would make the appearance of appliance lighting systems more appealing for all ambient and life cycle conditions while at the same time offering operational power saving features.

### BRIEF DESCRIPTION OF THE INVENTION

Aspects and advantages of the invention will be set forth in part in the following description, or may be obvious from the description, or may be learned through practice of the invention.

In some embodiments, the present subject matter relates to methodologies for providing compensation for light generation over the lifetime of a lighting device in an appliance. One or more lighting devices are installed in an appliance and one or both of ambient light proximate the appliance and lighting device conditions are monitored. Energization of the lighting devices is controlled to compensate for the monitored light condition so as to achieve compensation for existing conditions over the lifetime of the one or more lighting device.

In certain of the methods plural lighting devices are installed but only a single one of the plural lighting devices is monitored. One or more of the plural lighting devices are controlled based on the monitored condition of the single monitored device.

In certain embodiments of the method energization characteristics applied to the lighting devices are monitored and the devices are controlled based on the characteristics. In certain methods, the characteristics may correspond to at least one of time, type, or level of energization of the lighting devices.

In selected embodiments, the method provides for monitoring ambient light proximate the appliance and energizing at least one of the plural lighting devices based on the monitored ambient light.

In other selected methods, the method provides for monitoring light from one of the lighting devices and energizing at least one of the lighting devices based on the monitored light.

The present subject matter also relates to an appliance including a controller and at least one lighting device. A driver is coupled between the controller and the lighting device. An optical sensor and a feedback network are provided to provide the controller with signals related to light levels. The controller is configured to receive the light signals and to control energization of the lighting devices.

In certain embodiments the light signals may be indicative of ambient light while in others the signals indicate light levels from one of the lighting devices. In some embodiments, the apparatus includes at least two lighting devices. In these embodiments the controller is further configured to monitor at least one of the lighting devices and to control energizing of one or more of the lighting devices based on the monitored conditions.

In certain embodiments the feedback network is configured to monitor energization characteristics applied to the lighting device. In these embodiments the controller is configured to cause the driver to energize one or more of the lighting devices based on the monitored energization characteristics.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 schematically illustrates a life cycle lighting compensation system in accordance with present technology;

FIG. 2 schematically illustrates an ambient lighting compensation system in accordance with present technology;

FIG. 3 schematically illustrates a light sensor and feedback arrangement for providing a light level signal to a controller; and

FIG. 4 illustrates and exemplary appliance having a display with which the present subject matter may be incorporated.

Repeat use of reference characters throughout the present specification and appended drawings is intended to represent same or analogous features or elements of the invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As noted in the Summary section, the present subject matter is directed toward lifetime compensation for appliance lighting. As illustrated, in exemplary embodiments, the present subject matter may employ a controller and associated components and controlling software to determine ambient and system lighting conditions of an appliance and to adjust the system lighting conditions to compensate for given conditions.

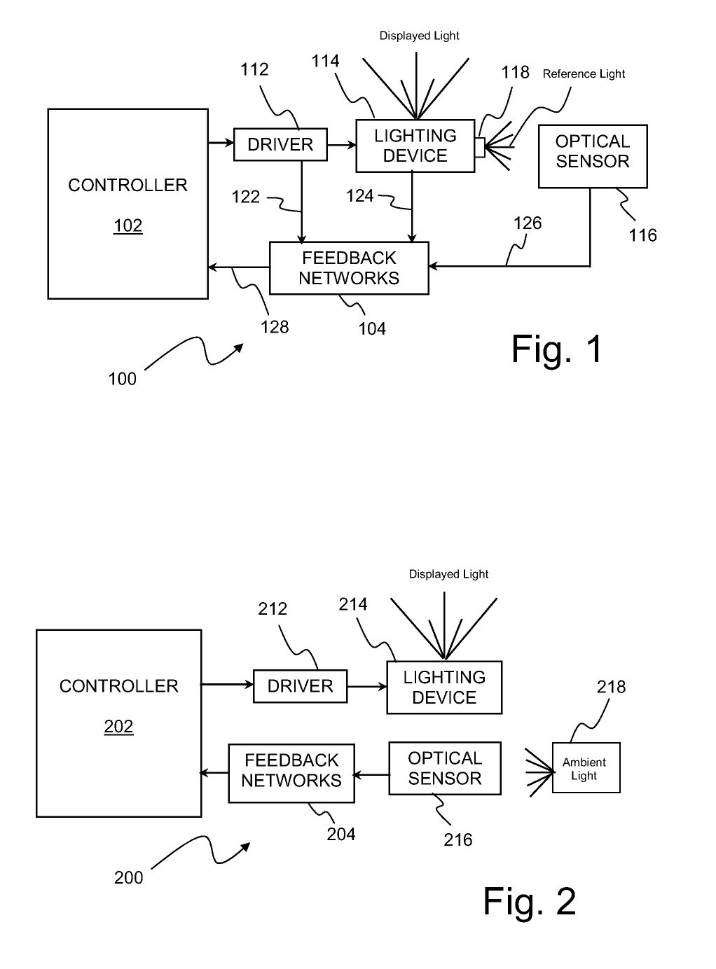

With reference now to FIG. 1, there is illustrated a life cycle lighting compensation system 100 in accordance with a first embodiment of the present subject matter. In particular, life cycle lighting compensation system 100 is provided with a controller 102 that receives input signals from multiple sources by way of feedback networks 104. These input signals generally correspond to operational signals derived from driver 112, lighting device 114, and optical sensor 116 conveyed to controller 102 by way of signal lines 122, 124, 126, respectively, feedback networks 104 and representative signal line 128 that may correspond to plural signal lines.

Signals transferred over line 122 from driver 112 to feedback networks 104 may correspond to such as drive current level, drive voltage level, type of drive signal including, for example, the general shape or other characteristics of the drive signal, that is, whether the drive signal is pulsed, triangular, sinusoidal, constant voltage, constant current, or of other form or characteristic. Signals transferred via line 124 from lighting device 114 may indicate, without limitation, such as, the total amount of time the device has operated, the temperature of the device, or other properties associated with the operation of the lighting device 114.

It should be appreciated at this point that while the present disclosure speaks generally of a controller 102 as receiving signals from and providing signals to various components, such is not a specific limitation of the present subject matter. Those of ordinary skill in the art will readily appreciate that other devices including, without limitation, application specific integrated circuits (ASIC), micro-processors, micro-controllers, general purpose computers, and other such devices may equally well be employed to implement the present subject matter.

Regardless of the particular hardware and/or software chosen to implement any particular embodiment of the present subject matter, the result would be an appliance lighting system that provides lighting at its highest visual quality during all operational conditions of the appliance.

A system constructed in accordance with the present technology is designed to monitor the lifetime lighting conditions of an appliance and to drive the lighting system higher or lower accordingly. For example, a discrete LED lighting system may be found to have a half life of five (5) years with LED brightness decreasing linearly over that time. Such a lighting system may be started by driving the LED using a pulse width modulation (PWM) scheme with a 25% duty cycle in the early life of the LED. By the time the LED is at half life, the duty cycle may be increased to 50% to accommodate and give the visual appearance of consistent LED lighting, that is, not a dim LED, that may be visually un-appealing or may be mismatched relative to other nearby LEDs that may be less frequently used.

In accordance with present technology, there a number of options that may be chosen to compensate for light source lifetime interactions. One option, as illustrated in FIG. 1, is to monitor reference light from a reference LED 118 as it impinges on optical sensor 116. Alternatively or in addition, the driving conditions of the lighting system may be monitored throughout the lifetime of the lighting device. For example, the driving conditions from driver 112 of lighting device 114 may be monitored via signals lines 122, 124 and feedback networks 104 to track how much lighting systems are used and at what power. In this instance, lighting device 114 that provides the displayed light may correspond to one or more similar light emitting device where one of the devices may correspond to a reference light source 118 whose light output is representative of that of the entire lighting device 114. Alternatively, reference light source 118 may correspond to the display light itself.

With reference now to FIG. 2, there is schematically illustrated an ambient lighting compensation system 200 in accordance with a further embodiment of the present technology. As will be appreciated by those of ordinary skill in the art, lighting schemes will generally appear differently in different ambient lighting conditions. Under such conditions lighting device 214 will be adjusted by the controller 202 through driver 212 to compensate for sensed ambient light 218 as transmitted to the controller 202 by optical sensor 216 and feedback network 204.

In an exemplary arrangement, an LED screen or 7-segment displays would be driven differently in darkness than in bright conditions when they could be driven at less power and still be visible without harshness to the eyes. Similar diverse driving requirements would be necessary for fluorescent lighting, incandescent lights, LED's, and other types of light emitting devices etc.

With reference to FIG. 3, there is schematically illustrated a light sensor 300 for providing a light level signal to a controller. Light sensor 300 may correspond to a photo diode 316 coupled to an adjustable gain amplifier 304. Photo diode 316 is configured to receive light from a light source 318 while signals generated by photo diode 316 are amplified by adjustable gain amplifier 304 and sent as an input signal to a controller. With reference to FIGS. 1 and 2, it will be seen that light sensor 300 may correspond to either or both optical sensor 116 and or optical sensor 216, responding to either ambient light as in system 200 of FIG. 2 or light from a reference light source as in system 100 of FIG. 1.

Given the above disclosure regarding systems 100 and 200, it should be further appreciated that features of the two systems may be combined to further enhance the consistency of long term lighting obtainable through use of the present technology.

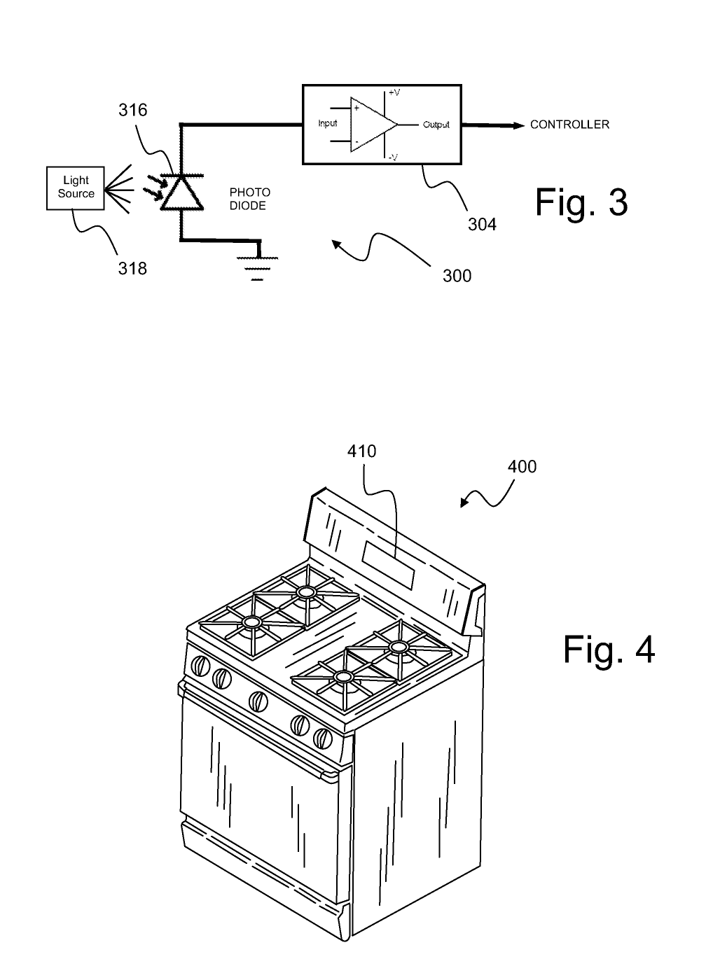

Referring to FIG. 4 there is illustrated an exemplary stove 400 including among other well recognized features, a display panel 410 that may generally include lighting device such as lighting devices 114 and 214 whose lighting consistence over the lifetime of the lighting device is to be monitored and controlled. It should, of course, be appreciated that the present subject matter is not limited to lighting device employed in stoves, but rather may be used in any appliance wherein lighting device may be provided.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for compensating for light generation over the lifetime of a lighting device in an appliance, comprising:
installing one or more lighting devices in an appliance;
monitoring at least one of ambient light proximate the appliance or device light conditions; and
controlling energization of the one or more lighting devices to compensate for the monitored light condition so as to achieve compensation for existing conditions over the lifetime of said one or more lighting device.

2. A method as in claim 1, wherein installing comprise installing plural lighting devices, wherein monitoring comprises monitoring a single one of the plural lighting devices, and wherein controlling comprises energizing all of the plural lighting devices based on the monitored condition of the single one of the plural lighting devices.

3. A method as in claim 1, further comprising:
monitoring energization characteristics applied to the one or more lighting devices; and
controlling energization of the one or more lighting devices based at least in part on the monitored energization characteristics.

4. A method as in claim 3, wherein monitoring energization characteristics comprises monitoring at least one of time, type, or level of energization of the one or more lighting devices.

5. A method as in claim 1, wherein monitoring comprises monitoring ambient light proximate the appliance, and wherein controlling comprises energizing at least one of the plural lighting devices based at least in part on the monitored ambient light.

6. A method as in claim 5, wherein monitoring further comprises monitoring light from at least one of the lighting devices, and wherein controlling further comprises energizing at least one of the lighting devices based at least in part on the monitored light from the at least one lighting device.

7. An appliance, comprising:
a controller;
at least one lighting device;
a driver coupled between said controller and said at least one lighting device;
an optical sensor; and
a feedback network,
wherein said controller is configured to receive signals from said optical sensor via said feedback network to monitor one or more of ambient light proximate said appliance or light from said at least one lighting device and to control energization of said at least one lighting device via said driver.

8. Apparatus as in claim 7, further comprising:
at least two lighting devices,
wherein said controller is further configured to monitor at least one of said at least two lighting devices, and to control energizing of one or more of said at least two lighting devices based at least in part on the monitored condition of said at least one of said at least two lighting devices.

9. Apparatus as in claim 8, wherein said feedback network is configured to monitor energization characteristics applied to said at least one of said at least two lighting device; and
wherein said controller is further configured to cause said driver to energize one or more of said at least two lighting devices based at least in part on the monitored energization characteristics.

10. Apparatus as in claim 9, wherein said energization characteristics correspond to at least one of time, type, and level of energization.

11. Apparatus as in claim 7, wherein said controller is further configured to monitor ambient light proximate the appliance, and to control energizing at least one of said at least one lighting devices based at least in part on the monitored ambient light.

12. Apparatus as in claim 11, wherein said controller is further configured to monitor light from at least one of said at least one lighting devices, and to control energizing at least one of said at least on lighting devices based at least in part on the monitored light from said at least one lighting device.
